(19) United States
(12) Patent Application Publication
(10) Pub. No.: US 2016/0358163 A1
(43) Pub. Date: Dec. 8, 2016

(54) PAYMENT TOKENIZATION USING FORMAT PRESERVING ENCRYPTION FOR SECURE TRANSACTIONS

(71) Applicant: CA, INC., New York, NY (US)

(72) Inventors: SHARATH LAKSHMAN KUMAR, Bangalore (IN); Mahesh Malatesh Chitragar, Bangalore (IN)

(73) Assignee: CA, INC., New York, NY (US)

(21) Appl. No.: 14/584,367

(22) Filed: Dec. 29, 2014

(51) Int. Cl. G06Q 20/38; G06Q 20/20; G06Q 20/36; G06Q 20/10

(52) U.S. Cl. CPC G06Q 20/3829; G06Q 20/10; G06Q 20/204; G06Q 20/3823; G06Q 20/3674

(57) ABSTRACT

A method includes communicating with a token server to identify a key, generating an initialization vector, performing a logical operation on the key using the initialization vector to generate a modified key, encrypting a financial account number using a format preserving encryption technique to generate a payment token where the format preserving encryption technique uses the modified key, establishing a communication connection with a point-of-sale terminal, and transmitting the payment token to the point-of-sale terminal.

### BACKGROUND

The present disclosure relates to computing systems, and, in particular, to computing system supporting secure payment through tokenization.

As payments technology evolves, new types of payment systems and techniques are being used to provide increased protection against counterfeit, account misuse, and other types of fraud. One technique that has been used is known as payment tokenization, which involves substituting a payment Primary Account Number (PAN) with a payment token in the payments ecosystem. Payment tokens may be used to originate payment transactions, while non-payment tokens may be used for other purposes, such as loyalty program tracking. A payment token service provider may be authorized to provide payment tokens to token requestors, such as card on file merchants, acquirer processors, payment gateways, digital wallet providers, card issuers, and the like. The token service provider may be implemented to run on a server and to receive requests for payment tokens from one or more token requestors. For each payment token request, the token service provider generates a random payment token, which is in some cases a Bank Identification Number (BIN)/Issuer Identification Number (IIN) range that is not currently being used by any active payment card. The token may be given some expiration period and can be used in place of the PAN for a payment card until it expires. Before the token expires, however, a hostile actor may eavesdrop on financial transaction communications in an attempt to determine what payment card number maps to a particular token.

Another potential security threat may stem from the use of mobile devices, which need to be online to request token(s) from the payment token service provider. An alternative is to pre-populate a mobile device with some number of payment tokens. Such an approach, however, may involve extra administration overhead at the payment token service provider, and the tokens may risk a greater likelihood of being compromised due to mobile devices being more susceptible to being stolen, misplaced, or compromised in some way.

### SUMMARY

In some embodiments of the inventive subject matter, a method comprises communicating with a token server to identify a key, generating an initialization vector, performing a logical operation on the key using the initialization vector to generate a modified key, encrypting a financial account number using a format preserving encryption technique to generate a payment token where the format preserving encryption technique uses the modified key, establishing a communication connection with a point-of-sale terminal, and transmitting the payment token to the point-of-sale terminal.

In other embodiments of the inventive subject matter, a method comprises communicating with a user device to identify a key, receiving a payment token from an issuer data processing system associated with a financial account number, determining an initialization vector used to generate the payment token, performing a logical operation on the key using the initialization vector to generate a modified key, decrypting the payment token using a format preserving encryption technique to obtain the financial account number where the format preserving encryption technique uses the modified key, and communicating the financial account number to the issuer data processing system.

In further embodiments of the inventive subject matter, a computer program product comprises a tangible computer readable storage medium. The tangible computer readable storage medium comprises computer readable program code embodied in the medium that when executed by a processor causes the processor to perform operations comprising: communicating with a token server to identify a key, generating an initialization vector, performing a logical operation on the key using the initialization vector to generate a modified key, encrypting a financial account number using a format preserving encryption technique to generate a payment token where the format preserving encryption technique uses the modified key, establishing a communication connection with a point-of-sale terminal, and transmitting the payment token to the point-of-sale terminal.

Other methods, systems, articles of manufacture, and/or computer program products according to embodiments of the inventive subject matter will be or become apparent to one with skill in the art upon review of the following drawings and detailed description. It is intended that all such additional systems, methods, articles of manufacture, and/or computer program products be included within this description, be within the scope of the present inventive subject matter, and be protected by the accompanying claims. Moreover, it is intended that all embodiments disclosed herein can be implemented separately or combined in any way and/or combination.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a block diagram of a system for facilitating secure payment transactions via tokenization using Format Preserving Encryption (FPE) in accordance with some embodiments of the inventive subject matter.

FIG. 2 illustrates a data processing system that may be used to implement the token server of FIG. 1 in accordance with some embodiments of the inventive subject matter.

FIG. 3 is a block diagram that illustrates a software/hardware architecture for the token server of FIG. 1 in accordance with some embodiments of the present inventive subject matter.

FIG. 4 is a block diagram that illustrates a mobile device/terminal in accordance with some embodiments of the present inventive subject matter.

FIGS. 5 and 6 are flowcharts that illustrate operations for facilitating secure payment transactions via tokenization using FPE in accordance with some embodiments of the inventive subject matter.

### DETAILED DESCRIPTION

In the following detailed description, numerous specific details are set forth in order to provide a thorough understanding of embodiments of the present disclosure. However, it will be understood by those skilled in the art that the present invention may be practiced without these specific details. In other instances, well-known methods, procedures, components and circuits have not been described in detail so as not to obscure the present invention. It is intended that all embodiments disclosed herein can be implemented separately or combined in any way and/or combination.

As used herein, a “service” includes, but is not limited to, a software and/or hardware service, such as cloud services in which software, platforms, and infrastructure are provided remotely through, for example, the Internet. A service may be provided using Software as a Service (SaaS), Platform as a Service (PaaS), and/or Infrastructure as a Service (IaaS) delivery models. In the SaaS model, customers generally access software residing in the cloud using a thin client, such as a browser, for example. In the PaaS model, the customer typically creates and deploys the software in the cloud sometimes using tools, libraries, and routines provided through the cloud service provider. The cloud service provider may provide the network, servers, storage, and other tools used to host the customer's application(s). In the IaaS model, the cloud service provider provides physical and/or virtual machines along with hypervisor(s). The customer installs operating system images along with application software on the physical and/or virtual infrastructure provided by the cloud service provider.

As used herein, the term “data processing facility” includes, but it not limited to, a hardware element, firmware component, and/or software component. A data processing system may be configured with one or more data processing facilities.

As used herein, the term “mobile terminal” or “mobile device” may include a satellite or cellular radiotelephone with or without a multi-line display; a Personal Communications System (PCS) terminal that may combine a cellular radiotelephone with data processing, facsimile and data communications capabilities; a PDA or smart phone that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver. Mobile terminals or mobile devices may also be referred to as “pervasive computing” devices.

Some embodiments of the inventive subject matter stem from a realization that a purchaser can use a mobile device to make a payment in which the mobile device generates a secure payment token using Format Preserving Encryption (FPE) to take the place of the Primary Account Number (PAN) in the payment ecosystem. In particular, the secure token is generated using FPE along with a dynamic initialization vector so that even if a hostile entity were to discover the keys used in the FPE operation, a PAN will not map to the same secure payment token number every time. The dynamic initialization vector may be based on such parameters as an expiration date for the payment token, a timestamp comprising both a current date and a current time that the payment token is transmitted to a point-of-sale (POS) terminal, an issuer identification number portion of the PAN, and/or a prime number.

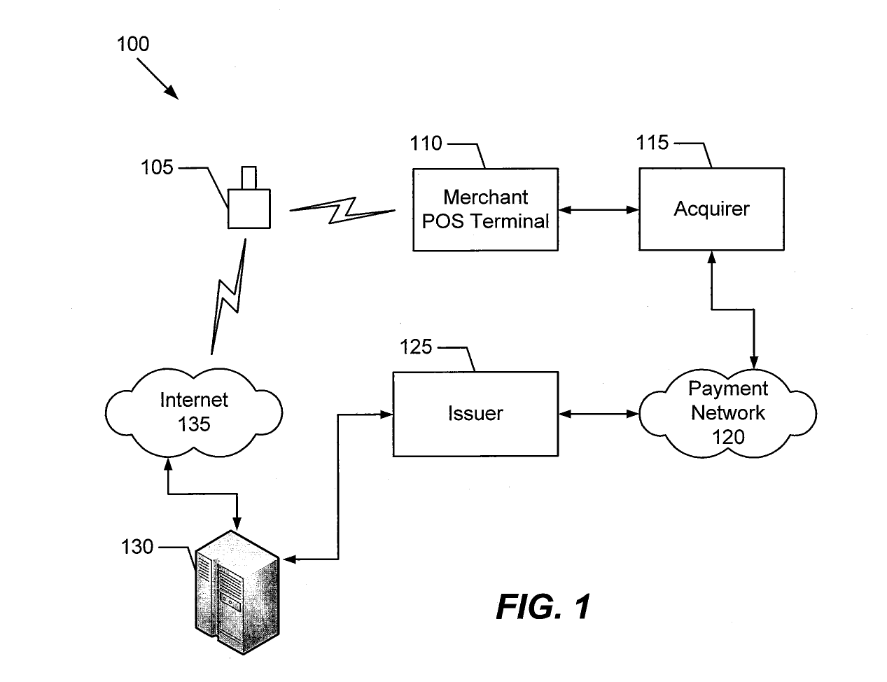

FIG. 1 is a block diagram that illustrates a system for facilitating secure payment transactions via tokenization using FPE according to some embodiments of the inventive subject matter. The system 100 comprises a Point Of Sale (POS) terminal 110 that may be operated, for example, in the store of a retailer or merchant. The POS terminal 110 may include a cash register that is managed by an attendant or may be a self-checkout register. The POS terminal 110 may be configured to scan products and read product codes. For example, the POS terminal 110 can be configured to read a UPC product bar code and/or a QR code. In some embodiments, the POS terminal 110 can be configured to scan and read other identifiers (i.e., codes) representative of a product. Once the products are scanned and read, the POS terminal 110 can be configured to generate transaction data and to receive payment associated with the products and/or services listed in the transaction data. The POS terminal 110 may receive payment from a shopper in a variety of ways including, but not limited to, cash, credit card, debit card, gift card, loyalty card, and reward card. The POS terminal 110 may be configured with communication functionality, such as Near Field Communication (NFC) functionality to receive payment information from a customer.

A shopper may provide payment information to the POS terminal 110 using a mobile device 105 that may include links to financial accounts thereon and/or data identifying various financial accounts, such as credit card accounts, store credit accounts, debit card accounts, checking accounts, loyalty program accounts, rewards accounts, and the like. The mobile device 105 may also include identification credentials, such as a photo identification, driver's license, passport, insurance card, home and/or work address information, home and/or work telephone numbers, and the like. In some embodiments, the financial information and/or personal identification information may be managed using a digital wallet application residing on the phone or in a cloud server on the Internet or other network.

The mobile device 105 may be configured to make a payment by generating a secure payment token locally using FPE to take the place of the PAN in the financial transaction. The secure payment token may be generated using FPE along with a dynamic initialization vector to ensure that the PAN will not map to the same secure payment token number every time a payment is made. The dynamic initialization vector may be based on such parameters as an expiration date for the payment token, a timestamp comprising both a current date and a current time that the payment token is transmitted to the POS terminal 110, an issuer identification number portion of the PAN, and/or a prime number. Unlike some conventional payment systems in which payment tokens are used, the mobile device 105 need not be online to request a token from a payment server.

As shown in FIG. 1, the POS terminal 110 is coupled to an acquirer server/data processing system 115, which represents the merchant's bank or other type of financial institution for processing payments received by the merchant. The acquirer server 115 is coupled to the issuer server/data processing system 125 via a payment network 120. The issuer server 125 may represent any institution providing a source of funds for a shopper's financial transaction including, but not limited to, banks, credit unions, retailers (e.g., store credit accounts/charge cards), mobile payment processors, such as Payfone™, and other financial institutions. It will be understood that the credit issuer may provide funds both through credit accounts and non-credit accounts, including a shopper's savings and/or checking account. The acquirer server 115 is coupled to the issuer server 125 via a payment network 120, which may be operated by an entity associated with the particular instrument used in a financial transaction. Such entities may include, but are not limited to, financial institutions, such as Visa, MasterCard, American Express, Discover Card, and the like who issue credit cards, debit cards, and other types of financial instruments used in financial transactions.

The issuer server 125 is coupled to a token server 130 via a secure connection. The secure payment token generated by the mobile device 105 is communicated to the issuer server 125 through the payment network 120. The issuer server 125, however, cannot determine the actual PAN used in the financial transaction from the secure payment token. Thus, the issuer server 125 communicates the secure payment token along with initialization vector information, such as expiration date for the secure payment token and/or the date that the secure payment token was transmitted to the merchant POS terminal 110 to initiate the transaction, to the token server 130 over a secure communication connection using, for example, Transport Layer Security (TLS) or Secure Socket Layer (SSL) protocols. As described above, the initialization vector may be based on such parameters as an expiration date for the payment token, a timestamp comprising both a current date and a current time that the payment token is transmitted to the POS terminal 110, an Issuer Identification Number (IIN) portion of the PAN, and/or a prime number. The prime number along with key(s) used in encrypting the PAN to generate the secure payment token may be agreed upon through one or more communication sessions between the token server 130 and the mobile device 105 over the Internet 135. These communication sessions may also be used to provide the token server 130 with information on what information the mobile device 105 uses to generate the initialization vector, i.e., expiration date for the payment token and/or a timestamp comprising both a current date and a current time that the payment token is transmitted to the POS terminal 110. The token server 130 may determine the initialization vector used in generating the secure payment token and, with knowledge of the key(s) used in the FPE operations by the mobile device 105, the token server 130 may decrypt the secure payment token to obtain the PAN. The token server 130 may communicate the PAN to the issuer server 125 over the secure connection with the issuer server 125 to allow the issuer server 125 to continue with settlement of the transaction by sending funds for the transaction to the merchant's account at the acquirer server 115.

The connections between the mobile device 105, POS terminal 110, acquirer server 115, issuer server 125, and token server 130 may include wireless and/or wireline connections and may be direct or include one or more intervening local area networks, wide area networks, and/or the Internet. The payment network 120 may be a global network, such as the Internet or other publicly accessible network. Various elements of the payment network 120 may be interconnected by a wide area network, a local area network, an Intranet, and/or other private network, which may not be accessible by the general public. Thus, the payment network 120 may represent a combination of public and private networks or a virtual private network (VPN). The payment network 120 may be a wireless network, a wireline network, or may be a combination of both wireless and wireline networks.

Although FIG. 1 illustrates a block diagram for facilitating secure payment transactions via tokenization using FPE according to some embodiments of the inventive subject matter, it will be understood that embodiments of the present invention are not limited to such configurations, but are intended to encompass any configuration capable of carrying out the operations described herein.

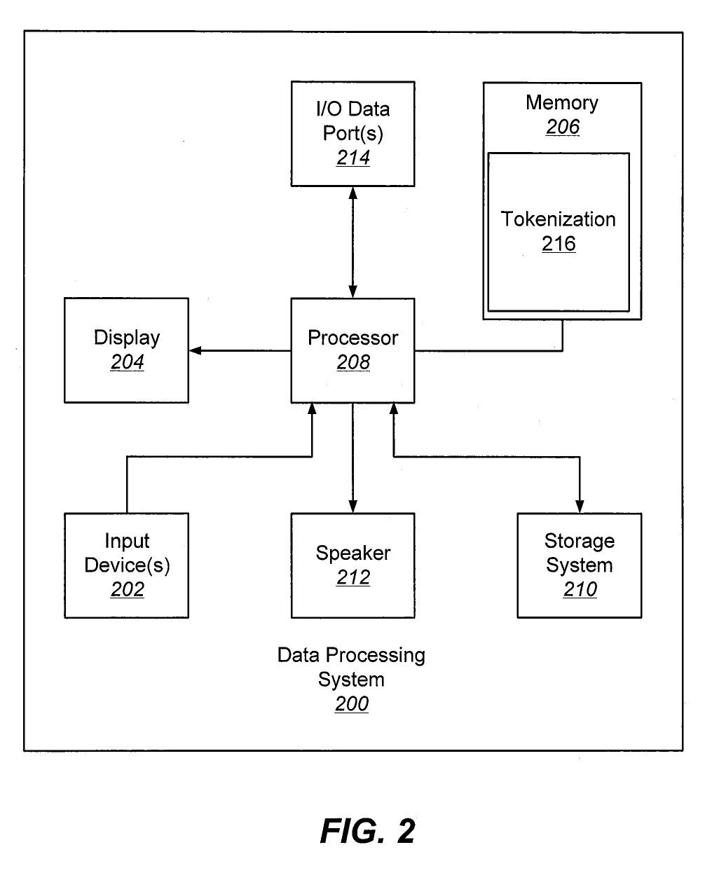

Referring now to FIG. 2, a data processing system 200 that may be used to implement the token server 130 of FIG. 1, in accordance with some embodiments of the inventive subject matter, comprises input device(s) 202, such as a keyboard or keypad, a display 204, and a memory 206 that communicate with a processor 208. The data processing system 200 may further include a storage system 210, a speaker 212, and an input/output (I/O) data port(s) 214 that also communicate with the processor 208. The storage system 210 may include removable and/or fixed media, such as floppy disks, ZIP drives, hard disks, or the like, as well as virtual storage, such as a RAMDISK. The I/O data port(s) 214 may be used to transfer information between the data processing system 200 and another computer system or a network (e.g., the Internet). These components may be conventional components, such as those used in many conventional computing devices, and their functionality, with respect to conventional operations, is generally known to those skilled in the art. The memory 206 may be configured with a tokenization module 216 that may be configured to communicate with the mobile device 105 to agree upon the parameters used in encrypting a PAN to generate a secure payment token as described above and to decrypt the secure payment token to obtain the original PAN for the issuer server 125 according to some embodiments of the inventive subject matter.

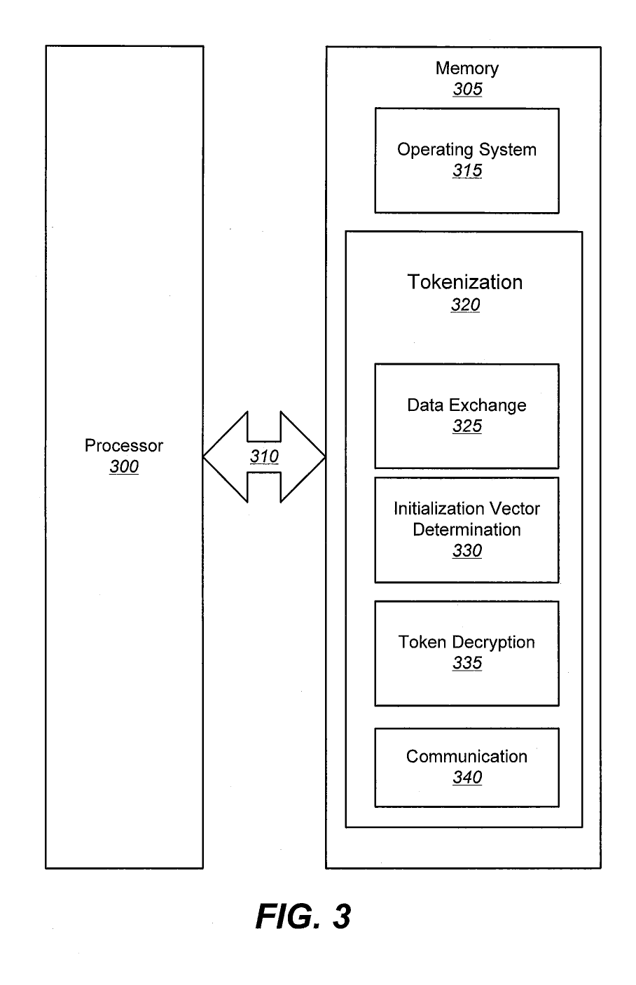

FIG. 3 illustrates a processor 300 and memory 305 that may be used in embodiments of data processing systems, such as the token server 130 of FIG. 1 and the data processing system 200 of FIG. 2, respectively, for facilitating secure payment transactions via tokenization using FPE in accordance with some embodiments of the inventive subject matter. The processor 300 communicates with the memory 305 via an address/data bus 310. The processor 300 may be, for example, a commercially available or custom microprocessor. The memory 305 is representative of the one or more memory devices containing the software and data used for facilitating secure payment transactions via tokenization using FPE in accordance with some embodiments of the inventive subject matter. The memory 305 may include, but is not limited to, the following types of devices: cache, ROM, PROM, EPROM, EEPROM, flash, SRAM, and DRAM.

As shown in FIG. 3, the memory 305 may contain up to two or more categories of software and/or data: an operating system 315 and a tokenization module 320. The operating system 315 generally controls the operation of the data processing system. In particular, the operating system 315 may manage the data processing system's software and/or hardware resources and may coordinate execution of programs by the processor 300. The tokenization module 320 includes a data exchange module 325, an initialization vector determination module 330, a token decryption module 335, and a communication module 340.

The data exchange module 325 may be configured to communicate with the mobile device 105 to agree upon the prime number along with key(s) used in encrypting the PAN to generate the secure payment token. The data exchange module 325 may be further used to obtain information on what information the mobile device 105 uses to generate the initialization vector, i.e., expiration date for the payment token and/or a timestamp comprising both a current date and a current time that the payment token is transmitted to the POS terminal 110.

The initialization vector determination module 330 may be configured to receive the secure payment token from the issuer server 125 and, based on the IIN, the expiration date for the payment token and/or the timestamp comprising both the current date and the current time that the payment token is transmitted to the POS terminal 110, and the prime number, determine the initialization vector.

The token decryption module 335 may be configured to decrypt the secure payment token received from the issuer server 125 based on the initialization vector determined by the initialization vector determination module 330 and knowledge of the key(s) used in the FPE operations by the mobile device 105 to obtain the PAN.

The communication module 340 may be configured to facilitate communication between the token server 130 and the mobile device 105 to support, for example, the data exchange module 325 as well as communication with the issuer server 125 to receive the secure payment token and to send the PAN back to the issuer server 125 after the secure payment token is decrypted.

Although FIG. 3 illustrates hardware/software architectures that may be used in data processing systems, such as the token server 130 of FIG. 1 and the data processing system 200 of FIG. 2, respectively, for facilitating secure payment transactions via tokenization using FPE, according to some embodiments of the inventive subject matter, it will be understood that the present invention is not limited to such a configuration but is intended to encompass any configuration capable of carrying out operations described herein.

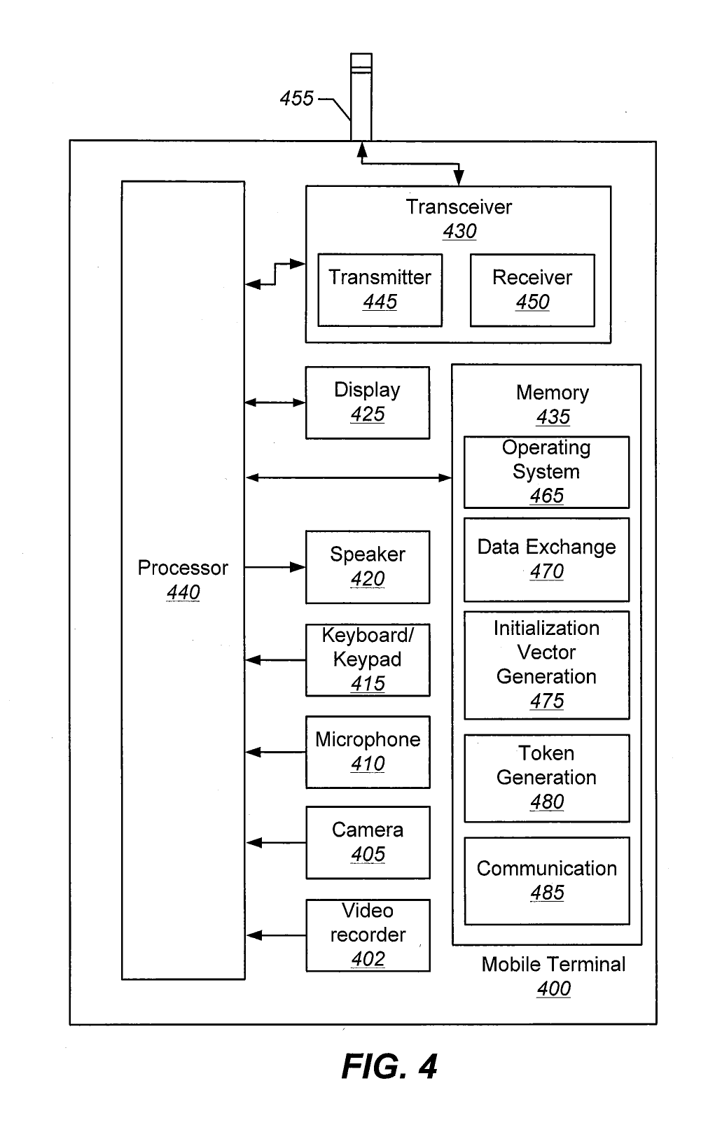

Referring now to FIG. 4, an exemplary mobile terminal 400 that may be used to implement the mobile device 105 of FIG. 1, in accordance with some embodiments of the inventive subject matter, includes a video recorder 402, a camera 405, a microphone 410, a keyboard/keypad 415, a speaker 420, a display 425, a transceiver 430, and a memory 435 that communicate with a processor 440. The transceiver 430 comprises a transmitter circuit 445 and a receiver circuit 450, which respectively transmit outgoing radio frequency signals to base station transceivers and receive incoming radio frequency signals from the base station transceivers via an antenna 455. The radio frequency signals transmitted between the mobile terminal 400 and the base station transceivers may comprise both traffic and control signals (e.g., paging signals/messages for incoming calls), which are used to establish and maintain communication with another party or destination. The radio frequency signals may also comprise packet data information, such as, for example, cellular digital packet data (CDPD) information. The foregoing components of the mobile terminal 400 may be included in many conventional mobile terminals and their functionality is generally known to those skilled in the art.

The processor 440 communicates with the memory 435 via an address/data bus. The processor 440 may be, for example, a commercially available or custom microprocessor. The memory 435 is representative of the one or more memory devices containing the software and data used to facilitate secure payment transactions via tokenization using FPE, in accordance with some embodiments of the present invention. The memory 435 may include, but is not limited to, the following types of devices: cache, ROM, PROM, EPROM, EEPROM, flash, SRAM, and DRAM.

As shown in FIG. 4, the memory 435 may contain up to five or more categories of software and/or data: the operating system 465, a data exchange module 470, an initialization vector generation module 475, a token generation module 480, and a communication module 485. The operating system 465 generally controls the operation of the mobile terminal 400. In particular, the operating system 465 may manage the mobile terminal's software and/or hardware resources and may coordinate execution of programs by the processor 440.

The data exchange module 470 may be configured to communicate with the token server 130 to agree upon the prime number along with key(s) used in encrypting the PAN to generate the secure payment token. The data exchange module 470 may be further used to share information with the token server 130 on what the mobile device 105 uses to generate the initialization vector, i.e., expiration date for the payment token and/or a timestamp comprising both a current date and a current time that the payment token is transmitted to the POS terminal 110.

The initialization vector generation module 475 may be configured to generate the initialization vector based on the IIN, the expiration date for the payment token and/or the timestamp comprising both the current date and the current time that the payment token is transmitted to the POS terminal 110, and the prime number.

The token generation module 480 may be configured to generate a secure payment token locally using FPE to take the place of the PAN in a financial transaction. The secure payment token may be generated using FPE along with the dynamic initialization vector provided by the initialization vector generation module 475. In some embodiments, the FPE operation may comprise a multiple round Feistel Network cipher using a different key in each of the rounds. The round function used in the Feistel Network cipher may be an Advanced Encryption Standard (AES) cipher.

The Feistel Network cipher operates as follows: The input, which may be the PAN in accordance with embodiments of the present inventive subject matter, may be broken into two parts: a left part L and a right part R. The part is logically combined through an exclusive OR operation with the encrypted value obtained using the plain text of the right part as input. The AES cipher is used in the encryption operation F( ) performed on the right part and the key. A different key may be used for each round. Moreover, the key may be modified with the initialization vector provided by the initialization vector generation module 475. In some embodiments, the modified key is obtained by performing a logical OR operation on the key and the initialization vector. Just as a different key value may be used in each round of the encryption operations, a different initialization vector may be used in each round of the encryption operation according to some embodiments of the inventive subject matter. The input text is padded and the padded value is truncated post encryption. This makes the process reversible and may help in the decryption operations. Formulas used for the encryption and decryption operations are set forth below. K represents the key modified with the initialization vector:

Encryption:

For each round i=0, 1, . . . , n, compute

Lᵢ₊₁=Rᵢ

Rᵢ₊₁=Lᵢ⊕F(Rᵢ, Kᵢ).

Then the cipher text is (Rₙ₊₁, Lₙ₊₁).

Decryption:

Decryption of a cipher text (Rₙ₊₁, Lₙ₊₁) is accomplished by computing for i=n, n−1, . . . , 0

Rᵢ=Lᵢ₊₁

Lᵢ=Rᵢ₊₁⊕F(Lᵢ₊₁, Kᵢ).

Then (L₀, R₀) is the plaintext again.

The communication module 485 may be configured to facilitate communication between the mobile device 105 and the token server 130 to support, for example, the data exchange module 470 as well as communication with the merchant POS terminal 110 to transmit the secure payment token in place of a PAN during a financial transaction.

Although FIG. 4 illustrates an exemplary software and hardware architecture that may be used to provide a mobile terminal that can facilitate secure payment transactions via tokenization using FPE according to some embodiments of the inventive subject matter, it will be understood that embodiments of the present invention are not limited to such a configuration, but are intended to encompass any configuration capable of carrying out the operations described herein.

Computer program code for carrying out operations of data processing systems discussed above with respect to FIGS. 1-4 may be written in a high-level programming language, such as Python, Java, C, and/or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

Moreover, the functionality of the mobile device 105 of FIG. 1, the token server 130 of FIG. 1, the data processing system 200 of FIG. 2, the hardware/software architecture of FIG. 3, and the mobile terminal of FIG. 4 may each be implemented as a single processor system, a multi-processor system, a multi-core processor system, or even a network of stand-alone computer systems, in accordance with various embodiments of the inventive subject matter. Each of these processor/computer systems may be referred to as a “processor” or “data processing system.”

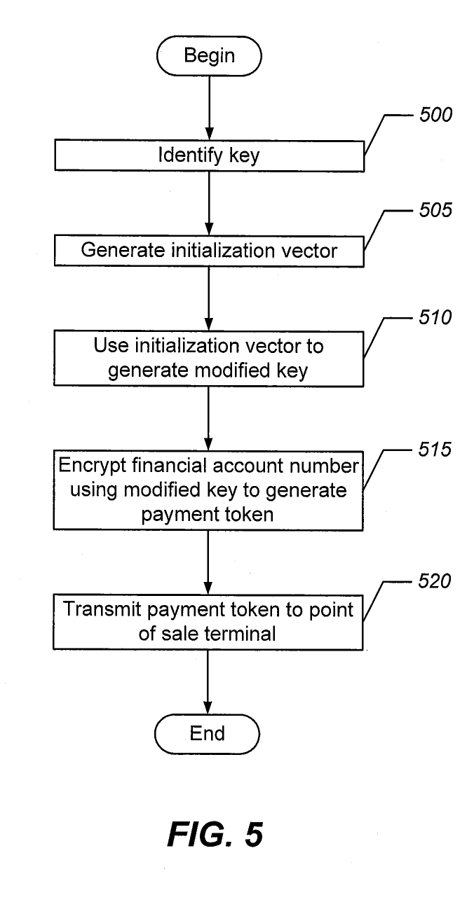

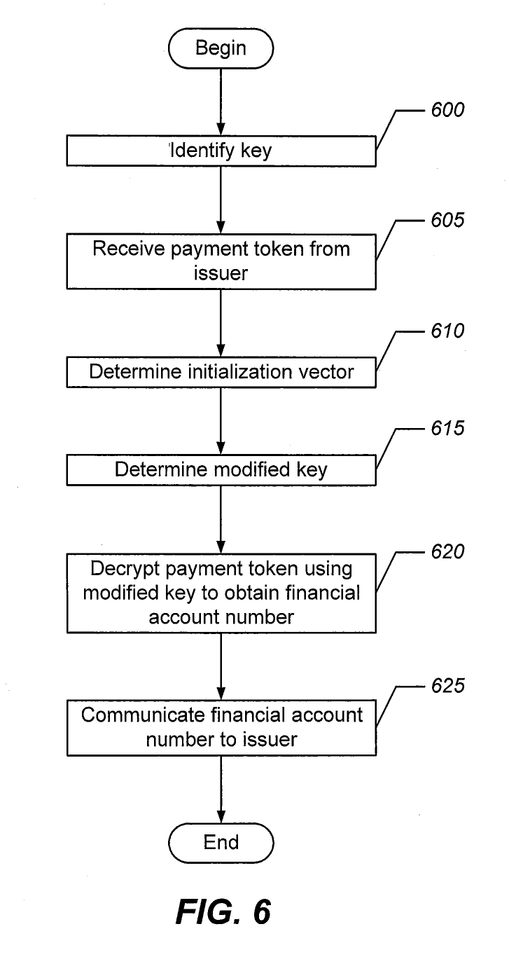

FIGS. 5 and 6 are flowcharts that illustrate operations for facilitating secure payment transactions via tokenization using FPE in accordance with some embodiments of the inventive subject matter. Referring now to FIG. 5, operations of a mobile device, such as mobile device 105/400, begin at block 500 where the one or more key's are identified. As described above, the data exchange module 470 of a mobile device 105 may communicate with the data exchange module 325 of the token server 130 to agree upon the prime number along with key(s) used in encrypting the PAN to generate the secure payment token.

The mobile device 105 at block 505 may generate the initialization vector using the initialization vector generation module 475. In some embodiments, the initialization vector may be generated by multiplying an expiration date for the payment token, the IIN portion of the PAN, and the prime number together. In other embodiments, the initialization vector may be generated by multiplying a timestamp comprising both a current date and a current time that the payment token is transmitted to the merchant POS terminal 110, the IIN portion of the PAN, and the prime number together. The data exchange module 470 may be used to share information with the token server 130 on what the mobile device 105 uses to generate the initialization vector, i.e., expiration date for the payment token and/or a timestamp comprising a current date and a current time that the payment token is transmitted to the POS terminal 110.

At block 510, the token generation module 480 uses the initialization vector to generate the modified key and, at block 515, encrypt the PAN using the modified key to generate the payment token. As described above, a multiple round Feistel Network cipher may be used as the FPE technique to generate the secure payment token. A different initialization vector may be generated and a different key may be used for each round.

At block 520, a communication connection may be established with the merchant POS terminal using, for example, but not limited to, NFC functionality, scanning a bar code, scanning a QR code, scanning text information, and the like. The secure payment token can then be used in the payment ecosystem of FIG. 1 to take the place of the PAN associated with a customer's purchase.

Referring now to FIG. 6, operations of a token server, such as the token server 130, begin at block 500 where the one or more key's are identified. As described above, the data exchange module 470 of a mobile device 105 may communicate with the data exchange module 325 of the token server 130 to agree upon the prime number along with key(s) used in encrypting the PAN to generate the secure payment token. The token server 130 at block 605 receives the secure payment token from the issuer server 125. At block 610, the initialization vector determination module 330 may determine the initialization vector based on the IIN, the expiration date for the payment token and/or the timestamp comprising the current date and the current time that the payment token is transmitted to the POS terminal 110, and the prime number. The token decryption module 335 may determine the modified key(s) at block 615 based on knowledge of the logical operation(s) performed to generate the modified key(s). As described above, in some embodiments, the modified key(s) are obtained by performing logical OR operation(s) on the key(s) and the initialization vector(s). The token decryption module 335 may then be used to decrypt the secure payment token received from the issuer server 125 based on the modified key(s) used in the FPE operations by the mobile device 105 to obtain the PAN. The PAN may then be communicated to the issuer server 125 over a secure communication link between the token server 130 and the issuer server 125 at block 625.

The systems, methods, and computer program products described herein regarding facilitating secure payment transactions via tokenization using FPE may be applied in a variety of different ways to enhance the operation of mobile devices, merchant servers, and bank/financial entity servers through improved security. Embodiments of the present inventive concept may be used in the authorization process, the settlement process, the merchant initiated reversal process, and/or the issuer initiated reversal (chargeback) process associated with financial transactions.

The authorization process, according to some embodiments, involves the mobile device generating a secure payment token using one or more keys and one or more initialization vectors. The secure payment token is used in place of a PAN for conducting a financial transaction and is provided to the merchant POS terminal. The merchant transmits the secure payment token along with other transaction details to the acquirer (e.g., merchant bank). The acquirer forwards the token along with the other transaction details through the payment network to the issuer. The issuer communicates with the token server to send the secure payment token along with the token expiration date, for example, which the token server uses to decrypt secure payment token to obtain the original PAN. The PAN is then forwarded back to the issuer through a secure communication channel.

The settlement process, according to some embodiments, is similar to the authorization process and involves a merchant submitting the transaction details (including the secure payment token) via the acquirer through the payment network to the issuer. The issuer communicates with the token server to send the secure payment token along with the token expiration date, for example, to get the token server to decrypt the secure payment token and obtain the original PAN. The token server sends the PAN back to the issuer who then proceeds with transferring funds in the amount of the transaction to the acquirer (e.g., merchant's bank).

The merchant initiated reversal process, according to some embodiments, involves the merchant sending the actual PAN details for a transaction through the acquirer to the issuer via the payment network. The issuer may then communicate with the token server to obtain audit and/or log information from the token server regarding the transaction to assist the issuer in communicating with the acquirer to refund the cost of the transaction to the customer's account. Sending the actual PAN details, however, may be less secure so the merchant may instead send a secure payment token instead by having, for example, the customer swipe/tap a smart phone or credit card instead. The process is similar, but the token server will now decrypt the secure payment token to obtain the PAN for the issuer.

The issuer initiated reversal, according to some embodiments, involves the issuer sending the actual card details, e.g., PAN, to the token server to obtain audit and/or log information associated with a particular transaction to assist the issuer in refunding the transaction cost to the customer's account.

The systems, methods, and computer program products described herein regarding facilitating secure payment transactions via tokenization using FPE may improve the operation of mobile devices, merchant servers, and/or bank/financial entity servers through improved security. An initialization vector generated for each round of a Feistel Network encryption process, for example, can ensure that a different payment token is obtained every time a PAN is encrypted. This makes secure payment token dynamic and increases the level of security. Moreover, the embodiments described herein provide an additional advantage in that the customer's mobile device may generate the secure payment token and a token server may decrypt the payment token as both entities are informed about what key(s) are used and what initialization vector is used as part of the encryption process.

Although the embodiments described herein have been directed to generating a secure payment token locally at a mobile device, such as mobile device 105, using FPE to take the place of a PAN in a financial transaction, in other embodiments, secure payment tokens may be generated in bulk on a token server, such as token server 130. The token server may then pre-populate the mobile device with tokens over the Internet 135, for example, at various times, upon request, and/or periodically. Such operations may be termed replenishment of the tokens on the mobile device. In some embodiments, when the mobile device is replenished with tokens from the token server, basing the dynamic initialization vector on the expiration date for the payment token along with an issuer identification number portion of the PAN and/or a prime number may be desirable.

### Further Definitions and Embodiments:

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

That which is claimed:

1. A method, comprising:
communicating with a token server to identify a key;
generating an initialization vector;
performing a logical operation on the key using the initialization vector to generate a modified key;
encrypting a financial account number using a format preserving encryption technique to generate a payment token, the format preserving encryption technique using the modified key;
establishing a communication connection with a point-of-sale terminal; and
transmitting the payment token to the point-of-sale terminal.

2. The method of claim 1, wherein the initialization vector is based on an expiration date for the payment token.

3. The method of claim 1, wherein the initialization vector is based on a timestamp comprising both a current date and a current time that the payment token is transmitted to the point-of-sale terminal.

4. The method of claim 1, wherein communicating with the token server to identify a key comprises communicating with the token server to identify a plurality of keys; and
wherein the format preserving encryption technique comprises a multiple round Feistel Network cipher using a different one of the plurality of keys in each of the rounds.

5. The method of claim 4, wherein a round function used in the Feistel Network cipher is an Advanced Encryption Standard (AES) cipher.

6. The method of claim 1, wherein generating the initialization vector comprises:
multiplying an expiration date for the payment token, an issuer identification number portion of the financial account number, and a prime number together.

7. The method of claim 1, wherein generating the initialization vector comprises:
multiplying a timestamp comprising both a current date and a current time that the payment token is transmitted to the point-of-sale terminal, an issuer identification number portion of the financial account number, and a prime number together.

8. The method of claim 1, wherein transmitting the payment token and the initialization vector to the point-of-sale terminal comprises transmitting the payment token and the initialization vector to the point-of-sale terminal using Near Field Communication (NFC).

9. A method, comprising:
communicating with a user device to identify a key;
receiving a payment token from an issuer data processing system associated with a financial account number;
determining an initialization vector used to generate the payment token;
performing a logical operation on the key using the initialization vector to generate a modified key;
decrypting the payment token using a format preserving encryption technique to obtain the financial account number, the format preserving encryption technique using the modified key; and
communicating the financial account number to the issuer data processing system.

10. The method of claim 9, wherein determining the initialization vector comprises determining the initialization vector based on an expiration date for the payment token.

11. The method of claim 10, wherein determining the initialization vector comprises determining the initialization vector based on the expiration date for the payment token, an issuer identification number, and a prime number.

12. The method of claim 9, wherein determining the initialization vector comprises determining the initialization vector based on a timestamp comprising both a current date and a current time that the payment token was transmitted to a point-of-sale terminal.

13. The method of claim 12, wherein determining the initialization vector comprises determining the initialization vector based on the timestamp, an issuer identification number, and a prime number.

14. The method of claim 9, wherein communicating with the user device to identify a key comprises communicating with the user device to identify a plurality of keys; and
wherein the format preserving encryption technique comprises a multiple round Feistel Network cipher using a different one of the plurality of keys in each of the rounds.

15. The method of claim 14, wherein a round function used in the Feistel Network cipher is an Advanced Encryption Standard (AES) cipher.

16. The method of claim 9, wherein communicating the financial account number to the issuer data processing system comprises:
communicating the financial account number to the issuer data processing system using a secure communication channel.

17. A computer program product, comprising:
a tangible computer readable storage medium comprising computer readable program code embodied in the medium that when executed by a processor causes the processor to perform operations comprising:
communicating with a token server to identify a key;
generating an initialization vector;
performing a logical operation on the key using the initialization vector to generate a modified key;
encrypting a financial account number using a format preserving encryption technique to generate a payment token, the format preserving encryption technique using the modified key;
establishing a communication connection with a point-of-sale terminal; and
transmitting the payment token to the point-of-sale terminal.

18. The computer program product of claim 17, wherein the initialization vector is based on an expiration date for the payment token.

19. The computer program product of claim 17, wherein the initialization vector is based on a timestamp comprising both a current date and a current time that the payment token is transmitted to the point-of-sale terminal.

20. The computer program product of claim 17, wherein generating the initialization vector comprises:
multiplying an expiration date for the payment token, an issuer identification number portion of the financial account number, and a prime number together.
